(19) United States
(12) Patent Application Publication
(10) Pub. No.: US 2009/0260987 A1
(43) Pub. Date: Oct. 22, 2009

(54) METHOD OF MAKING GAS SENSOR ELEMENT, AND GAS SENSOR DERIVED THEREFROM

(76) Inventors: Carlos A. Valdes, Flint, MI (US); Jinping Zhang, Grand Blanc, MI (US); Raymond L. Bloink, Swartz Creek, MI (US); Fenglian Chang, Grand Blanc, MI (US); Da Yu Wang, Troy, MI (US); Walter T. Symons, Grand Blanc, MI (US); Sheng Yao, Macomb, MI (US)

Correspondence Address: CANTOR COLBURN, LLP, 20 Church Street, 22nd Floor, Hartford, CT, 06103, US

(21) Appl. No.: 12/105,539

(22) Filed: Apr. 18, 2008

(51) Int. Cl. G01N 27/26

(52) U.S. Cl. 204/424

(57) ABSTRACT

Disclosed herein is a method of making a gas sensor element, comprising calcining a NOx sensor electrode material at a NOx sensor electrode material calcination temperature of about 1200 to about 1600° C. to form a calcined NOx sensor electrode material, disposing the calcined NOx sensor electrode material on a substrate to form a substrate comprising a NOx sensor electrode, and firing the substrate comprising the NOx sensor electrode at a gas sensor element firing temperature to form a gas sensor element comprising a NOx sensor electrode. Also disclosed is a gas sensor comprising the gas sensor element.

### BACKGROUND

Combustion engines that run on fossil fuels generate exhaust gases. The exhaust gases can include undesirable pollutants. Non-limiting examples of undesirable pollutants include nitrogen oxide gases (NOx), unburned hydrocarbon gases (HC), and carbon monoxide gas (CO). The automotive industry uses exhaust gas sensors in automotive vehicles to sense the composition of the exhaust gases for pollution control. For example, HC emissions can be reduced using sensors that can sense the composition of oxygen gas (O₂) in the exhaust gases for alteration and optimization of the air to fuel ratio for combustion.

Some automotive vehicles utilize various pollution-control after treatment devices such as NOx absorber(s), selective catalytic reduction (SCR) catalyst(s), and/or the like, to reduce NOx emissions. NOx reduction is accomplished by using ammonia gas (NH₃), which can be generated from the reaction of urea with steam. In order for SCR catalysts to function efficiently and to avoid pollution breakthrough, a feedback control system is used to manage the regeneration cycle of the NOx traps. NH₃ sensors are used for the feedback control system to be more effective. One group of NH₃ sensors operate based on the Nernst Principle, that is, the sensor converts chemical energy from NH₃ into electromotive force (emf). The sensor can measure this electromotive force to determine the partial pressure of NH₃ in a sample gas. However, such sensors also convert the chemical energy from NOx into emf. This undesirable sensing of NOx by the NH₃ sensor is corrected using NOx sensor cells and/or NOx sensors. NOx sensor cells and/or NOx sensors can sometimes suffer from slow and/or inconsistent response time, which hinders their efficiency.

Therefore, there exists a need for NOx sensor cells and/or sensors with faster and more consistent response time.

### SUMMARY

The above-described and other drawbacks are alleviated by a method of making a gas sensor element, comprising calcining a NOx sensor electrode material at a NOx sensor electrode material calcination temperature of about 1200 to about 1600° C. to form a calcined NOx sensor electrode material, disposing the calcined NOx sensor electrode material on a substrate to form a substrate comprising a NOx sensor electrode, and firing the substrate comprising the NOx sensor electrode at a gas sensor element firing temperature to form a gas sensor element comprising a NOx sensor electrode.

In one embodiment, a gas sensor comprises a gas sensor element prepared by calcining a NOx sensor electrode material at a NOx sensor electrode material calcination temperature of about 1200 to about 1600° C. to form a calcined NOx sensor electrode material, disposing the calcined NOx sensor electrode material on a substrate to form a substrate comprising a NOx sensor electrode, and firing the substrate comprising the NOx sensor electrode at a gas sensor element firing temperature to form a gas sensor element comprising a NOx sensor electrode.

### BRIEF DESCRIPTION OF THE DRAWINGS

Referring now to the drawings wherein like elements are numbered alike in several FIGURES:

FIG. 1 is an exploded view of an exemplary gas sensor element;

FIG. 2 is a partial cross-sectional view of a gas sensor comprising an exemplary gas sensor element;

FIGS. 3 and 4 are scanning electron microscope (“SEM”) photomicrographs of the microstructure of a NOx electrode material comprising TbCr_{0.8}Mg_{0.20}O₃;

FIGS. 5 and 6 are SEM photomicrographs of the interface between an alumina dielectric layer, a TbCr_{0.8}Mg_{0.2}O₃ NOx sensor electrode, and a zirconia solid electrolyte in two NOx sensor cells; and

FIGS. 7 and 8 are graphical representations of the response time for NOx sensor cells.

### DETAILED DESCRIPTION

Surprisingly, the present inventors have discovered that a method of making a gas sensor element, comprising calcining a NOx sensor electrode material at a NOx sensor electrode material calcination temperature (“CalcineTemp”) of about 1200° C. to about 1600° C. to form a calcined NOx sensor electrode material, disposing the calcined NOx sensor electrode material on a substrate to form a substrate comprising a NOx sensor electrode, and firing the substrate comprising the NOx sensor electrode at a gas sensor element firing temperature (“FiringTemp”) to form a gas sensor element comprising a NOx sensor electrode, results in the gas sensor element having improved and more consistent response time.

The gas sensor element can be a NOx sensor element, or any type of gas sensor element where NOx sensing can be advantageous. Non-limiting examples of gas sensor elements where NOx sensing can be advantageous include O₂ sensors, H₂ sensors, CO sensors, HC sensors, and NH₃ sensor elements. A combination comprising at least one of the foregoing can also be used. In one embodiment, the gas sensor element is a NOx sensor element. In another embodiment, the gas sensor element is an NH₃ sensor element.

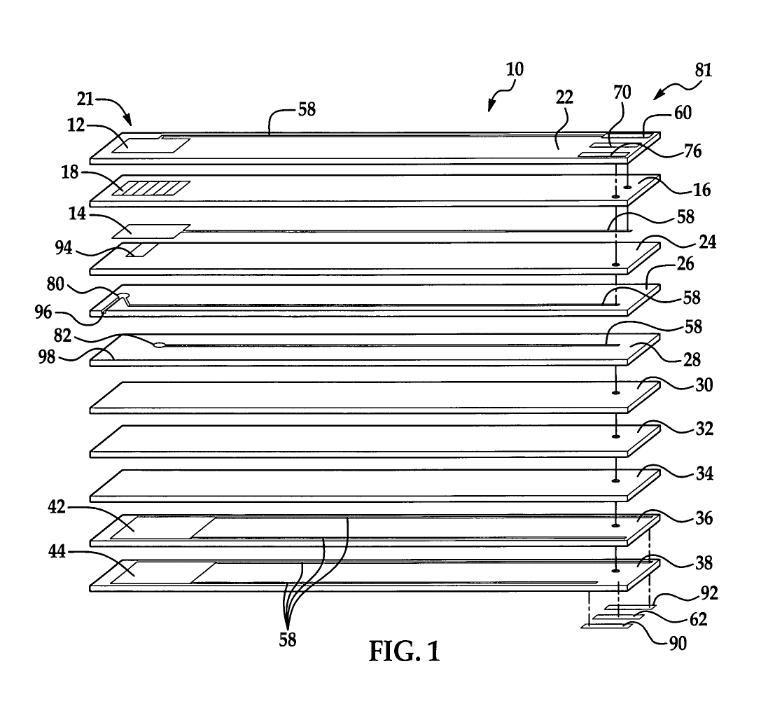

Referring now to FIG. 1, an exploded view of an exemplary gas sensor element 10 is shown. It is to be understood that although the invention is described in relation to a flat plate sensor, other two and three dimensional sensor designs can also be employed, such as conical, cylindrical, and the like.

The gas sensor element 10 comprises a NOx sensor cell 12/16/14 (or 12/18/14) comprising a NOx sensor electrode 12, a reference electrode 14, and a solid electrolyte layer 16 comprising a solid electrolyte 18. The NOx sensor cell 12/16/14 (or 12/18/14) is disposed at a sensing end 21 of the gas sensor element 10.

The solid electrolyte 18 can comprise the entire solid electrolyte layer 16 (such configuration not shown) or a portion thereof, and generally comprises any solid electrolyte material that permits the transfer of ions, such as, but not limited to, oxygen ions, while inhibiting (i.e., limiting or advantageously stopping) the physical passage of gases. The solid electrolyte 18 is not limited by size, and can be any size capable of providing sufficient ionic communication for the NOx sensor cell, for a plurality of cells, and/or for other cells and/or components. Generally, the solid electrolyte 18 and the solid electrolyte layer 16 have a thickness of about 25 to about 500 micrometers (μm), and more specifically about 30 to about 400 μm. In one advantageous embodiment, the thickness of the solid electrolyte layer 16 and the solid electrolyte 18 is about 50 to about 200 μm.

Non-limiting examples of solid electrolyte materials include zirconia, ceria, calcia, yttria, lanthanum oxide, magnesia, indium oxide, and the like, as well as combinations comprising at least one of the foregoing solid electrolyte materials. In one advantageous embodiment, the solid electrolyte 18 comprises zirconia. In another advantageous embodiment, the solid electrolyte 18 comprises zirconia which is stabilized with respect to, among others, polymorphism, high temperature phase transformation, and the like, with calcium, barium, yttrium, magnesium, aluminum, lanthanum, cesium, gadolinium, ytterbium, scandium, or the like, or oxides thereof, or combinations comprising at least one of the foregoing solid electrolyte materials.

In one exemplary embodiment, the solid electrolyte 18 comprises yttria stabilized zirconia. The yttria stabilized zirconia can comprise up to about 16 weight percent (wt %) yttria, based on a total weight of the yttria stabilized zirconia. Specifically, The yttria stabilized zirconia can comprise about 2 to about 14 wt % yttria, based on the total weight of the yttria stabilized zirconia. In one advantageous embodiment, the yttria stabilized zirconia can comprise about 3 to about 12 wt % yttria, based on the total weight of the yttria stabilized zirconia.

The solid electrolyte layer 16 can be formed using any method available to one with ordinary skill in the art including, but not limited to, doctor blade slurry casting, die pressing, roll compaction, stenciling, screen printing, and the like. In one advantageous embodiment, the solid electrolyte layer 16 is formed using a tape process utilizing any suitable ceramic tape casting method. If the solid electrolyte layer 18 comprises a portion of the solid electrolyte layer 16, a stamping method can also be used whereby the solid electrolyte 18 is disposed into an opening in the solid electrolyte layer 16 or attached onto an end of the solid electrolyte layer 16.

The reference electrode 14 is in intimate contact and ionic communication with the solid electrolyte 18 (and/or the solid electrolyte layer 16). It can comprise any suitable reference electrode material, such as any metal and/or metal catalyst capable of producing an electromotive force across the solid electrolyte 18 when the sensor electrode 12 is in contact with NOx. Non-limiting examples of the foregoing metals and/or metal catalysts include platinum (Pt), palladium (Pd), gold (Au), osmium (Os), rhodium (Rh), iridium (Ir), ruthenium (Ru), and the like, as well as alloys, oxides, and combinations comprising at least one of the foregoing. In one advantageous embodiment, the reference electrode 14 comprises platinum, which exhibits an elevated processing temperature, and is readily available commercially as an ink.

With respect to the size and geometry of the reference electrode 14, it is generally adequate to provide current output sufficient to effect a reasonable signal resolution over a wide range of NOx concentrations. Generally, a thickness of about 1 to about 25 μm can be employed, more specifically a thickness of about 5 to about 20 μm, and with a thickness of about 10 to about 18 μm being advantageous. In one advantageous embodiment, the geometry of the reference electrode 14 is substantially similar to the geometry of the solid electrolyte 18.

The reference electrode 14 can be formed using any suitable technique such as chemical vapor deposition, screen printing, sputtering, and stenciling, among others, in any combination, with screen printing of inks or pastes that include the electrode material onto appropriate tapes being advantageous due to simplicity, economy, and compatibility with the subsequent firing process. For example, reference electrode 14 can be screen printed onto an abutting layer 24 or the underside of the solid electrolyte 18. Further, the reference electrode 14 can be embedded within either of the above layers.

The NOx sensor electrode 12 is disposed on a substrate, the substrate comprising the solid electrolyte 18 (or solid electrolyte layer 16) and reference electrode 14, to form gas sensor element 10 comprising NOx sensor cell 12/18/14 or 12/16/14. It is to be understood that as used herein, “substrate” refers to a gas sensor element comprising the solid electrolyte layer 16 (and/or the solid electrolyte 18) having the reference electrode 14 disposed thereon, but not the NOx sensor electrode 12. The substrate, however, is not limited only to the foregoing, but can further comprise any of the other components of the gas sensor element (aside from the NOx sensor electrode 12).

The NOx sensor electrode 12 is disposed in intimate contact and ionic communication with the solid electrolyte layer 16, more specifically, with the solid electrolyte 18, and can be disposed such that it is operative for fluid communication with a sample gas, such as a gas being monitored or tested for its NOx concentration.

The NOx sensor electrode 12 comprises a calcined NOx sensor electrode material, which can comprise any NOx sensor electrode material capable of converting chemical energy from NOx into emf. Advantageous NOx sensor electrode materials can further conduct electricity, diffuse NOx, or both. Advantageous NOx sensor electrode materials can include binary metal oxides, ternary metal oxides, quaternary metal oxides, quinary metal oxides, senary metal oxides, septenary metal oxides, octonary metal oxides, nonary metal oxides, denary metal oxides, or a combination comprising at least one of the foregoing metal oxides.

Non-limiting examples of NOx sensor electrode materials include oxides of ytterbium (Yb), chromium (Cr), terbium (Tb), europium (Eu), erbium (Er), zinc (Zn), neodymium (Nd), iron (Fe), magnesium (Mg), gadolinium (Gd), as well as other materials suitable for sensing NOx, and a combination comprising at least one of the foregoing. Such combinations include, but are not limited to, YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, ZnCr₂O₄, and the like. A combination comprising at least one of the foregoing can also be used. In one embodiment, the NOx sensor electrode material is TbCrO₃.

The NOx sensor electrode material can further include a dopant. Non-limiting examples of dopants include barium (Ba), titanium (Ti), tantalum (Ta), potassium (K), calcium (Ca), strontium (Sr), vanadium (V), silver (Ag), cadmium (Cd), lead (Pb), tungsten (W), tin (Sn), manganese (Mn), nickel (Ni), zinc (Zn), sodium (Na), zirconium (Zr), niobium (Nb), cobalt (Co), magnesium (Mg), rhodium (Rh), boron (B), phosphorus (P), germanium (Ge), aluminum (Al), silicon (Si), a lanthanoid element such as samarium (Sm), europium (Eu), erbium (Er), neodymium (Nd), gadolinium (Gd), or holmium (Ho), and the like, as well as a combination comprising at least one of the foregoing dopants.

In one embodiment, the NOx sensor electrode material is TbCrO₃, doped with Mg, to produce TbCrₓMg₁₋ₓO₃, wherein x is less than or equal to 1, more specifically about 0.5 to about 0.95, and even more specifically about 0.7 to about 0.9. In one exemplary embodiment, x is 0.8. In another embodiment, the TbCrₓMg₁₋ₓO₃ is further doped with a lanthanoid element other than Tb, Ca, Sr, B, Pb, P, Ge, Ba, Si, Al, or a combination comprising at least one of the foregoing.

In one advantageous embodiment, the NOx sensor electrode 16 comprises a calcined NOx sensor electrode material selected from the group consisting of TbCr_{0.8}Mg_{0.20}O₃, TbCr_{0.8}Mg_{0.15}B_{0.05}O₃, TbCr_{0.8}Mg_{0.1}B_{0.1}O₃, TbCr_{0.7}Mg_{0.1}B_{0.2}O₃, TbCr_{0.5}Mg_{0.1}B_{0.4}O₃, TbCr_{0.8}Mg_{0.19}Pb_{0.01}O₃, TbCr_{0.8}Mg_{0.15}Pb_{0.05}O₃, TbCr_{0.8}Mg_{0.15}P_{0.05}O₃, Tb_{0.99}La_{0.01}Cr_{0.8}Mg_{0.175}B_{0.025}O₃, TbCr_{0.8}Ba_{0.20}O₃, and TbCr_{0.8}Si_{0.20}O₃.

The calcined NOx sensor electrode material is formed by calcining the NOx sensor electrode material at the CalcineTemp. Calcining the NOx sensor electrode material comprises mixing metal oxide precursors. Metal oxide precursors can be metal oxides, or any material comprising the metal that can oxidize under calcining conditions. The metal oxide precursors are used in an amount depending on the desired final composition of the NOx sensor electrode material, and can be easily determined by a person of ordinary skill in the art. For example, if a TbCr_{0.8}Mg_{0.20}O₃ NOx sensor electrode material is desired, and the individual metal oxides are used as precursors, Tb₄O₇ is mixed with Cr₂O₃ and MgO in a 0.25:0.2:0.4 molar ratio, respectively. The metal oxide precursors are mixed using any suitable method to produce an intimate homogeneous mixture, such as by milling, by using a mortar and pestle, or the like.

The CalcineTemp is generally about 1200 to about 1600° C., more specifically about 1250 to about 1550° C., more specifically about 1300 to about 1500° C., and even more specifically about 1350 to about 1450° C. In one advantageous embodiment, the CalcineTemp is about 1375 to about 1425° C.

The CalcineTemp can be the same as or different from the FiringTemp. In general, the CalcineTemp is no more than about 50° C. less than the FiringTemp. Specifically, the CalcineTemp is no more than about 25° C. less than the FiringTemp. In one advantageous embodiment, the CalcineTemp is equal to or greater than the FiringTemp.

Calcining at the CalcineTemp is for about 1 to about 20 hours, specifically about 3 to about 17 hours, and more specifically about 5 to about 15 hours. In one advantageous embodiment, calcining at the CalcineTemp is for about 10 hours.

Prior to calcining the NOx sensor electrode material at the CalcineTemp, the mixture of metal oxide precursors can be calcined together at different temperatures and for a different period of time. There is no limit as to the number of these pre-calcinations, but in general they are performed at temperatures below the CalcineTemp.

In one embodiment, prior to calcining the NOx sensor electrode material at the CalcineTemp, the mixture of metal oxide precursors can be calcined at a first NOx sensor electrode material precursor calcination temperature (“PreCalcineTemp1”) to form a first NOx sensor electrode material precursor (“Precursor1”). The Precursor1 is then calcined at the CalcineTemp.

The PreCalcineTemp1 is generally less than the CalcineTemp, and can be about 100 to about 1050° C., more specifically about 200 to about 1000° C., more specifically about 300 to about 950° C., more specifically about 400 to about 900° C., more specifically about 500 to about 850° C., more specifically about 600 to about 800° C., and even more specifically about 700° C.

Calcining at the PreCalcineTemp1 is for about 1 to about 30 hours, specifically about 3 to about 27 hours, more specifically about 6 to about 24 hours, more specifically about 9 to about 21 hours, and even more specifically about 12 to about 19 hours. It is advantageous to calcine at the PreCalcineTemp1 for about 10 hours or more. In one embodiment, calcining at the PreCalcineTemp1 is for about 10 to about 30 hours. In another embodiment, calcining at the PreCalcineTemp1 is for about 12 to about 19 hours.

In one advantageous embodiment, Tb₄O₇ is mixed with Cr₂O₃ and MgO, and the mixture is calcined at a PreCalcineTemp1 of about 800 to about 1000° C. for about 15 to about 20 hours, to form the Precursor1.

In another advantageous embodiment, Tb₄O₇ is mixed with Cr₂O₃ and MgO, and the mixture is calcined at a PreCalcineTemp1 of about 800 to about 1000° C. for about 8 to about 13 hours. The mixture is allowed to cool, and is remixed using, for example, milling or a mortar and pestle, and is again calcined at the PreCalcineTemp1 of about 800 to about 1000° C. for about 8 to about 13 hours, to form the Precursor1.

In another embodiment, following the calcination at the PreCalcineTemp1, and prior to calcining at the CalcineTemp, the Precursor1 is calcined at a second NOx sensor electrode material precursor calcination temperature (“PreCalcineTemp2”) to form a second NOx sensor electrode material precursor (“Precursor2”). The Precursor2 is then calcined at the CalcineTemp.

The PreCalcineTemp2 is generally less than the CalcineTemp. The PreCalcineTemp2 is also generally greater than the PreCalcineTemp1. Specifically, the PreCalcineTemp2 is about 200 to about 1140° C., more specifically about 300 to about 1100° C., more specifically about 400 to about 1050° C., more specifically about 500 to about 1000° C., more specifically about 700 to about 950° C., more specifically about 800 to about 900° C., and even more specifically about 850° C. In one advantageous embodiment, the PreCalcineTemp2 is greater than the PreCalcineTemp1.

Calcining at the PreCalcineTemp2 is for about 2 to about 60 hours, specifically about 10 to about 58 hours, more specifically about 20 to about 55 hours, more specifically about 30 to about 53 hours, and even more specifically about 35 to about 50 hours.

In one advantageous embodiment, following the calcination at PreCalcineTemp1, the Precursor1 is calcined at a PreCalcineTemp2 of about 1000 to about 1200° C. for about 35 to about 50 hours to produce Precursor2. Precursor2 is then calcined at a CalcineTemp to produce the desired calcined NOx sensor electrode material.

While not wishing to be bound by theory, it is believed that prior calcinations such as the pre-calcinations disclosed above are advantageous in producing reaction intermediates that can bring the reactants in closer proximity to one another, thus facilitating the calcination process and increasing its efficiency. One with ordinary skill in the art can easily determine the amount of necessary pre-calcinations, and the temperature at which they are performed.

After the formation of the desired calcined NOx sensor electrode material at the CalcineTemp, the calcined NOx sensor electrode material is disposed on the solid electrolyte 18 (and the solid electrolyte layer 16) to form NOx sensor cell 12/16/14 (or 12/18/14), comprising sensor electrode 12. This can be effected using any suitable deposition application or other technique available to one with ordinary skill in the art including, but not limited to, spray coating, painting, dip coating, screen printing, laminating, and the like.

In one advantageous embodiment, disposing is effected by screen printing. In this embodiment, the calcined NOx sensor electrode material can be made into an ink, which also refers to a paste or other fluid form suitable for screen printing, and disposed onto the solid electrolyte 18.

The ink can further comprise a binder, a carrier, a wetting agent, and the like, and combinations comprising at least one of the foregoing. The binder can be any material capable of providing adhesion between the ink and the substrate. Non-limiting examples of binders include acrylic resin, acrylonitrile, styrene, poly(acrylic acid), poly(methacrylic acid), poly(methyl acrylate), poly(methyl methacrylate), and the like, as well as combinations comprising at least one of the foregoing binders. Carriers include any material suitable for imparting desired printing, drying, and rheological characteristics of the ink. Non-limiting examples of carriers include volatile solvents which can dissolve polymer resins such as butyl acetate. Non-limiting examples of wetting agents include ethanol, isopropyl alcohol, methanol, cetyl alcohol, calcium octoate, zinc octoate and the like, as well as combinations comprising at least one of the foregoing.

The different constituents of the ink can be present in different amounts depending on the nature of the materials, and the product, and can be readily determined by a person with ordinary skill in the art. In general, the binder can be present in about 1 to about 40 wt %, the carrier can be present in about 1 to about 40 wt %, the wetting agent can be present in about 1 to about 20 wt %, and the calcined NOx sensor electrode material can be present in about 15 to about 98 wt %, based on the total weight of the ink.

In one embodiment, the ink comprises about 10 to about 30 wt % of 1-methoxy-2-propanol acetate, about 10 to about 30 wt % butyl acetate, about 5 to about 10 wt % acrylic resin, 0.1 to about 5 wt % poly(methyl methacrylate), about 5 to about 10 wt % ethanol, and about 30 to about 60 wt % of the calcined NOx sensor electrode material, based on the total weight of the ink.

Fugitive materials can also be used in the ink formulations to produce a desired porosity in the final NOx sensor electrode, that is, a sufficient porosity to enable the NOx to enter the NOx sensor electrode and reach triple points (points where the electrode, electrolyte, and NOx meet to enable the desired reactions). Fugitive materials are materials that degrade leaving voids upon firing. Some non-limiting examples of fugitive materials include graphite, carbon black, starch, nylon, polystyrene, latex, other soluble organics (e.g., sugars and the like), and the like, as well as combinations comprising one or more of the foregoing fugitive materials. The fugitive material can be present in an amount of about 0.1 to about 20 wt %, based on the total weight of the ink.

The gas sensor element 10 comprises insulating layers 22, 24, 28, 34, 36, 38, and active layers, which include the solid electrolyte layer 16 and layers 26, 30, and 32. The active layers can conduct ions, where the insulating layers can insulate sensor components from electrical and ionic conduction. In an exemplary embodiment, the electrolyte layer 16 is disposed between insulating layers 22 and 24, active layer 26 is disposed between insulating layers 24 and 28, and active layers 30 and 32 are disposed between insulating layers 28 and 34.

The gas sensor element 10 can further comprise a temperature sensor (not shown), an air-fuel sensor cell comprising the active layer 26 along with an electrode 80 and an electrode 82 (80/26/82), a heater 44 disposed between the insulating layers 36 and 38, and an electromagnetic shield 42 (also known as a ground plane layer) disposed between the insulating layers 34 and 36. A first inlet 94 is defined by a first surface of the insulating layer 24 and by a surface of the solid electrolyte layer 16, proximate the reference electrode 14. A second inlet 96 is defined by a first surface of the active layer 26 and a second surface of the insulating layer 24, proximate the electrode 80. In addition, the gas sensor element 10 comprises electrical lead 58, contact pads 60, 62, 70, 76, 90, 92, and can also include additional ground plane layer(s) (not shown), and the like.

The air-fuel sensor cell (80/26/82) can detect the air to fuel ratio of the sample gas. When a constant potential is applied to electrodes 80 and 82, the current through the air-fuel sensor cell 80/26/82 is limited by the oxygen available in the inlet 96 and at the electrodes 80, 82. Therefore, by measuring the current at the air-fuel sensor cell 80/26/82, a processor, such as a control module adapted to receive the signal output and determine the air-to-fuel ratio of the gas can be used. This same cell can also be used for sensing the temperature of the gas. In this mode an AC signal can be applied to the electrodes 80 and 82, and the impedance of the electrolyte 26 between the two electrodes 80 and 82 is used for temperature determination.

The heater 44 can be employed to maintain the gas sensor element 10 at a selected operating temperature. The heater 44 can be positioned as part of the monolithic design of the gas sensor element 10, for example between insulating layer 36 and insulating layer 38, in thermal communication with the air-fuel sensor cell 80/26/82 and the NOx sensor cell 12/16/14 (or 12/18/14). In other embodiments, the heater can be in thermal communication with the cells without necessarily being part of a monolithic laminate structure with them, e.g., simply by being in close physical proximity to a cell. More specifically, the heater can be capable of maintaining the sensing end 21 of the gas sensor element 10 at a sufficient temperature to facilitate the various electrochemical reactions therein. The heater can be a resistance heater and can comprise a line pattern (connected parallel lines, serpentine, and/or the like). The heater can comprise, for example, platinum, aluminum, palladium, and the like, as well as combinations comprising at least one of the foregoing, oxides comprising at least one of the foregoing metals. Contact pads, for example, contact pad 90 and contact pad 92, can transfer current to the heater from an external power source.

The temperature sensor (not shown) comprises any temperature sensor capable of monitoring the temperature of the sensing end 21 of the gas sensor element 10, such as an impedance-measuring device or a metal-like resistance-measuring device. The metal-like resistance temperature sensor can comprise, for example, a line pattern (connected parallel lines, serpentine, and/or the like). Some possible materials include, but are not limited to, electrically conductive materials such as metals including platinum (Pt), copper (Cu), silver (Ag), palladium (Pd), gold (Au), tungsten (W), as well as combinations comprising at least one of the foregoing.

Disposed between the insulating layers 34 and 36 can be an electromagnetic interference (“EMI”) shield 42. The EMI shield 42 isolates electric and/or magnetic fields and associated electrical interference and creates a barrier between a high power portion (such as the heater) and a low power portion (such as the temperature sensor and the gas sensing cell). The EMI shield can comprise, for example, a line pattern (various pad configurations, connected parallel lines, serpentine, cross-hatch pattern, and/or the like). Some possible materials for the shield can include those materials discussed above in relation to the heater.

At the sensing end 21 of the gas sensor element 10, the electrical leads 58 are disposed in intimate contact and in electrical communication with electrodes 12, 14, 80, and 82. Further, electrical leads 58 are disposed in electrical communication with the heater 44 and the electromagnetic shield 42. Each electrical lead extends from a contact pad or conductive via toward the sensing end 21. Electrical leads not disposed on a top surface or a bottom surface of the gas sensor element 10 are in electrical communication with the contact pads through conductive vias formed in and through the layers. Two sets of three contact pads are disposed at the terminal end 81 of the gas sensor element 10: the first, second, and third contact pads 60, 70, and 76 are disposed on the upper surface of the gas sensor element 10, and the fourth, fifth and sixth contact pads 62, 90, and 92 are disposed on the lower surface of the gas sensor element 10. The first, second, third, and fourth contact pads 60, 62, 70, and 76 are in electrical communication with a processor (not shown), and the fifth and sixth contact pads are in electrical communication with an external power source (not shown).

The insulating layers 22, 24, 28, 34, 36, 38 can comprise a dielectric material such as alumina, other insulating ceramics, and the like. Each of the insulating layers can comprise a sufficient thickness to attain the desired insulating and/or structural properties. For example, each insulating layer can have a thickness of about 1 to about 200 μm, depending upon the number of layers employed, or, more specifically, a thickness of about 50 to about 200 μm. Further, the gas sensor element 10 can comprise additional insulating layers to isolate electrical devices, segregate gases, and/or to provide additional structural support.

The active layers 26, 30, and 32 can comprise material that, while under the operating conditions of gas sensor element 10, is capable of permitting the electrochemical transfer of oxygen ions. These include the same or similar materials to those described as comprising solid electrolyte layer 16 and/or solid electrolyte 18. Each of the active layers can comprise a thickness of up to about 200 μm, depending upon the number of layers employed, or, more specifically, a thickness of about 50 to about 200 μm.

The gas sensor element 10 can be formed using various ceramic processing techniques. For example, milling processes (e.g., wet and dry milling processes including ball milling, attrition milling, vibration milling, jet milling, and the like) can be used to size ceramic powders into desired particle sizes and desired particle size distributions to obtain physical, chemical, and electrochemical properties. The ceramic powders can be mixed with plastic binders to form various shapes. For example, the structural components (e.g., insulating layers 22, 24, 28, 34, 36, and 38 and the active 26, 30, 32) can be formed into “green” tapes by tape-casting, roll-compacting, or similar processes. The processes include the above described processes used for forming the solid electrolyte 18, the solid electrolyte layer 16, the NOx sensor electrode 12 and the reference electrode 14.

Once the gas sensor element is formed, which, as described above, comprises the NOx sensor electrode material, it can be fired (i.e. sintered/calcined) at FiringTemp to allow controlled burn-off of the binders and other organic and inorganic materials and to form the ceramic material with desired microstructural properties, thus forming the gas sensor element 10 comprising the NOx sensor cell (12/16/14 or 12/18/14).

There is no limit as to the FiringTemp, which can be selected depending on the type of active layers, insulating layers, and the like. Generally, the FiringTemp is no more than about 50° C. higher than the CalcineTemp, and more specifically, no more than about 25° C. higher than the CalcineTemp. In one embodiment, the FiringTemp is about 1000 to about 1500° C., more specifically about 1100° C. to about 1450° C., more specifically about 1200° C. to about 1400° C., even more specifically about 1300° C. to about 1350° C.

Firing at the FiringTemp can be effected for a suitable amount of time, determined by one with ordinary skill in the art. For example, firing the gas sensor element can be effected for about 0.1 to about 20 hours, specifically from about 1 to about 10 hours, more specifically from about 2 to about 5 hours. It is generally advantageous to avoid firing at temperatures higher than 1500° C. to avoid adversely affecting some of the components of the gas sensor element 10, and to save energy.

During the manufacture of the gas sensor element 10, all the different components can be sintered and/or fired simultaneously at the FiringTemp, or certain components and/or plurality of different components can be fired and/or sintered separately, assembled, then fired and/or sintered and/or calcined together to form the gas sensor element 10. Regardless of how the final gas sensor element 10 is formed, the NOx sensor electrode material is calcined at the CalcineTemp to form the calcined NOx sensor electrode material, prior to forming the NOx sensor electrode 12.

The NOx sensor cell 12/16/14 (or 12/18/14) can generate emf according to the Nernst Equation. The sample gas is introduced to the NOx sensor electrode 12 and is diffused throughout the pores of the electrode. The calcined NOx sensor electrode material induces catalytic reactions in the sample gas. These reactions include catalyzing the formation of NO and H₂O from NO₂, and catalyzing the formation of NO₂ from N0 and O²⁻. Similarly, in the reference electrode 14, the catalytic material induces catalytic reactions in the reference gas, converting equilibrium oxygen O₂ to O²⁻ or vice versa, and thereby producing emf. Therefore, the electrical potential difference between the NOx sensor electrode 12 and the reference electrode 14 can be measured to determine the emf.

The partial pressure of reactive components at the electrodes can be determined from the cell's emf by using the Nernst Principle, as described, for example, in U.S. patent application Ser. No. 11/538,240.

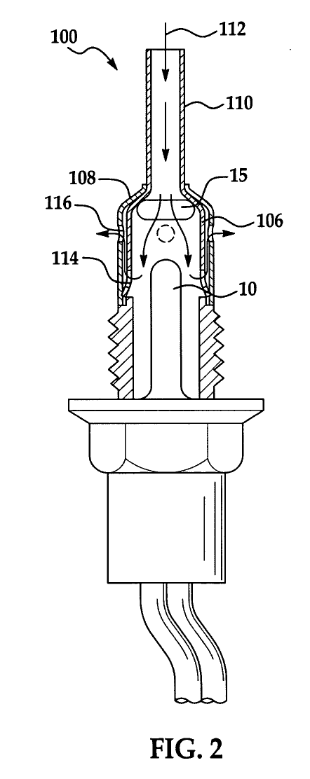

Referring to FIG. 2, for placement in a gas stream, a gas sensor comprises gas sensor element 10, is disposed within a protective casing 100. The protective casing 100 can comprise an outer shield 108 having a plurality of outer shield passages 116. An inner shield 106 comprises a plurality of passages 114, which allows fluid to enter a space between the inner shield 106 and the outer shield 108. Outer shield passages 116 allow fluid in the space between inner shield 106 and outer shield 108 to exit the casing 100. An optional sampling tube 110 having an inlet 112 extends from the outer shield 108. The sampling tube opens into a catalyst 15 proximate gas sensor element 10. Arrows are shown to illustrate the general fluid flow direction within the protective casing.

The plurality of exhaust passages 114 can be disposed through inner shield 106 to allow the exhaust fluid a sufficient residence time to contact the gas sensor element 10 and be sensed prior to exiting the protective casing 100. The plurality of exhaust passages 114 can be any size, number, or shape sufficient to allow the passage of exhaust fluid.

Suitable materials for the protective casing 100 can include material that is capable of resisting under-car salt, temperature, and corrosion. For example, ferrous materials are employed such as various stainless steels. Stainless steels can include those such as SS-409, SS-316, and the like.

The catalyst 15 can be disposed in the exhaust stream, upstream from the gas sensor element 10. The catalyst 15 can comprise material(s) capable of catalyzing the decomposition or conversion of hydrocarbons, carbon monoxide, ammonia, and/or hydrogen into water, nitrogen, and/or carbon dioxide. In one embodiment, the catalyst 15 comprises a material that, under the operating conditions of gas sensor element 10, is capable of efficiently converting NO to NO₂. In another embodiment, the catalyst 15 can comprise material(s) that, under the operating conditions of the gas sensor element 10, are capable of converting NO₂ to NO. The catalyst 15 can comprise materials including platinum (Pt), alloys thereof, and the like, as well as combinations comprising at least one of the foregoing. The catalyst 15 can further comprise zeolite(s) (e.g., alumina-silica zeolite powder).

The catalyst 15 can be disposed proximate various locations in the casing 100. In general, the catalyst 15 can be disposed at a location in which the sample gas can sufficiently contact the catalyst 15 upstream from the gas sensor element 10. For example the catalyst 15 can be disposed proximate the sampling tube 110 or can be disposed proximate the inner surface of the inner shield 106. The catalyst 15 can also be disposed outside the casing 100 upstream from the gas sensor element 10. For example, the catalyst 15 can be part of a catalyst bed reactor, upstream from the inlet 112 of the casing 100. In an exemplary embodiment, the gas sensor element 10 is disposed in an exhaust stream in fluid communication with engine exhaust. In addition to NH₃, O₂, and NOx, the gas sensor element's operating environment comprises other combustion by-products, for example, HC, H₂, CO, water, sulfur, sulfur-containing compounds, and/or combustion radicals (such as hydrogen and hydroxyl radicals), and the like.

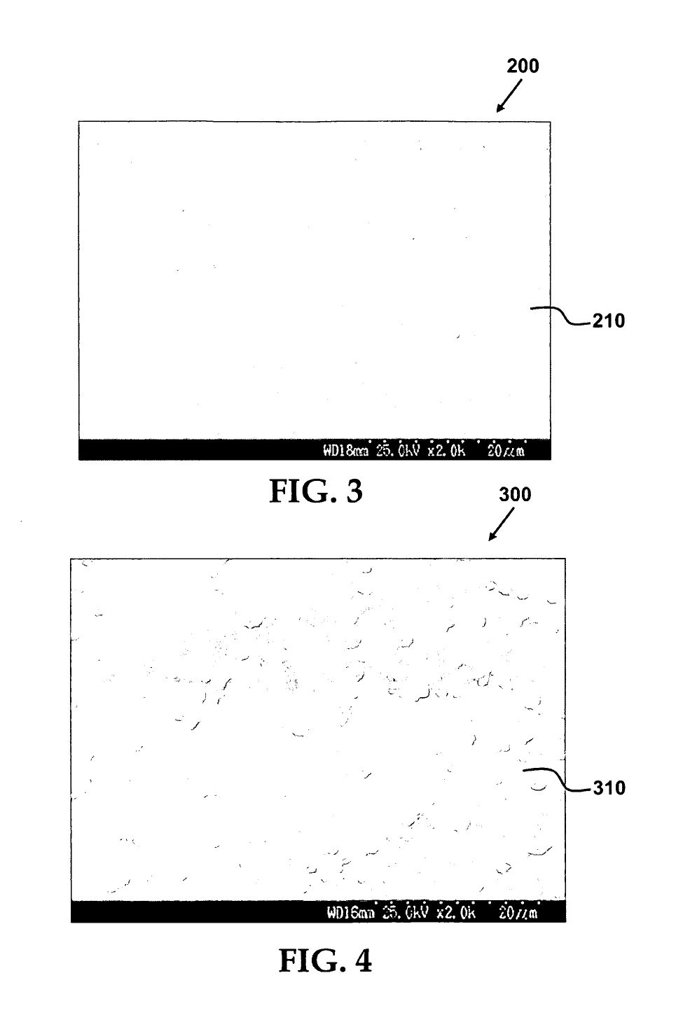

Referring now to FIGS. 3 and 4, FIG. 3 is a SEM photomicrograph of the microstructure of a NOx electrode material 200 comprising TbCr_{0.8}Mg_{0.20}O₃, which has been calcined at 1000° C. for 19 hours, and then at 1100° C. for 43 hours, prior to deposition on a solid zirconia electrolyte and firing at 1375 to 1425° C. for 1 hour. FIG. 4 is a SEM photomicrograph of the microstructure of a NOx electrode material 300 comprising TbCr_{0.8}Mg_{0.20}O₃, which has been calcined at 1000° C. for 19 hours, and then at 1100° C. for 43 hours, followed by calcining at 1400° C. for 10 hours, prior to deposition on a solid zirconia electrolyte and firing at 1375 to 1425° C. for 1 hour. The TbCr_{0.8}Mg_{0.20}O₃ used in FIG. 3 and FIG. 4 was produced from calcining a mixture of the individual metal oxides in the appropriate stoichiometric ratio. The materials used in FIG. 3 and FIG. 4 had the same average particle size.

It can be seen that at the same magnification, the morphology of the NOx electrode 310 in FIG. 4 exhibits coarser and more coalesced features than the morphology of the NOx electrode 210 in FIG. 3. Not wishing to be bound by theory, but it is believed that calcining at the NOx sensor electrode material calcination temperature of about 1200 to about 1600° C. allows the metal oxide precursors and the NOx sensor electrode material to react more fully, thus allowing any intermediate oxides (such as binary oxides) to complete the reaction to form the desired NOx electrode material.

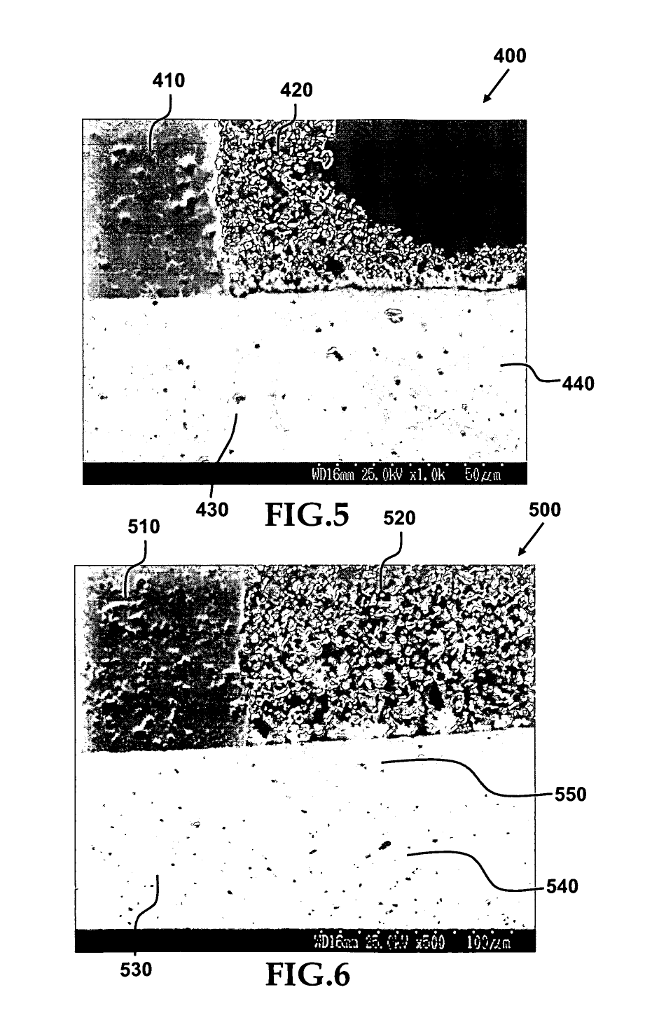

Referring now to FIGS. 5 and 6, SEM photomicrographs are shown of the interface between an alumina dielectric layer 410, 510, a TbCr_{0.8}Mg_{0.20}O₃ NOx sensor electrode 420,520, and a zirconia solid electrolyte 430, 530, in two NOx sensor cells 400, 500. The two NOx sensor cells were prepared by first forming substrates comprising the alumina dielectric layer 410, 510, the zirconia solid electrolyte 430, 530, and a reference electrode (not shown). The substrates were assembled together and fired at 1450° C. for 2 hours to form the sintered structure shown in FIGS. 5 and 6.

A TbCr_{0.8}Mg_{0.20}O₃ ink was formulated to contain 99 wt % TbCr_{0.8}Mg_{0.20}O₃ and 1 wt % glass binder. The powders were of a −325 mesh particle size. The glass used was a metal sealing glass with a softening point of 710° C. and a coefficient of thermal expansion which was half of that of the zirconia electrolyte. A low ash organic vehicle was added to allow for screen printing of the electrode. The ink was printed on each substrate to form NOx sensor cells, which were dried at 70° C. for 10 minutes and then fired at 1375 to 1425° C. for 1 hour. The TbCr_{0.8}Mg_{0.20}O₃ used in FIG. 5 was formed by calcining at 1000° C. for 19 hours, and then at 1100° C. for 43 hours, prior to screen printing. The TbCr_{0.8}Mg_{0.20}O₃ used in FIG. 6 was formed by calcining at 1000° C. for 19 hours, and then at 1100° C. for 43 hours, followed by calcining at 1400° C. for 10 hours, prior to screen printing. It can be seen from FIG. 5 that the zirconia microstructure has been altered at the section interfacing with the NOx sensor electrode 430. The altered microstructure propagates through the zirconia layer. In FIG. 6, however, very little to no alteration in the zirconia microstructure 540 is produced.

Not wishing to be bound by theory, but it is believed that in FIG. 5, lacking a calcination at the NOx sensor electrode material calcination temperature of about 1200 to about 1600° C., unreacted material in the NOx sensor electrode material migrates to the zirconia, where it reacts resulting in altering the zirconia microstructure. In FIG. 6, however, calcining at the NOx sensor electrode material calcination temperature of about 1200 to about 1600° C. allows for the electrode material to fully react, thus minimizing and/or eliminating the formation and/or propagation of the altered zirconia microstructure.

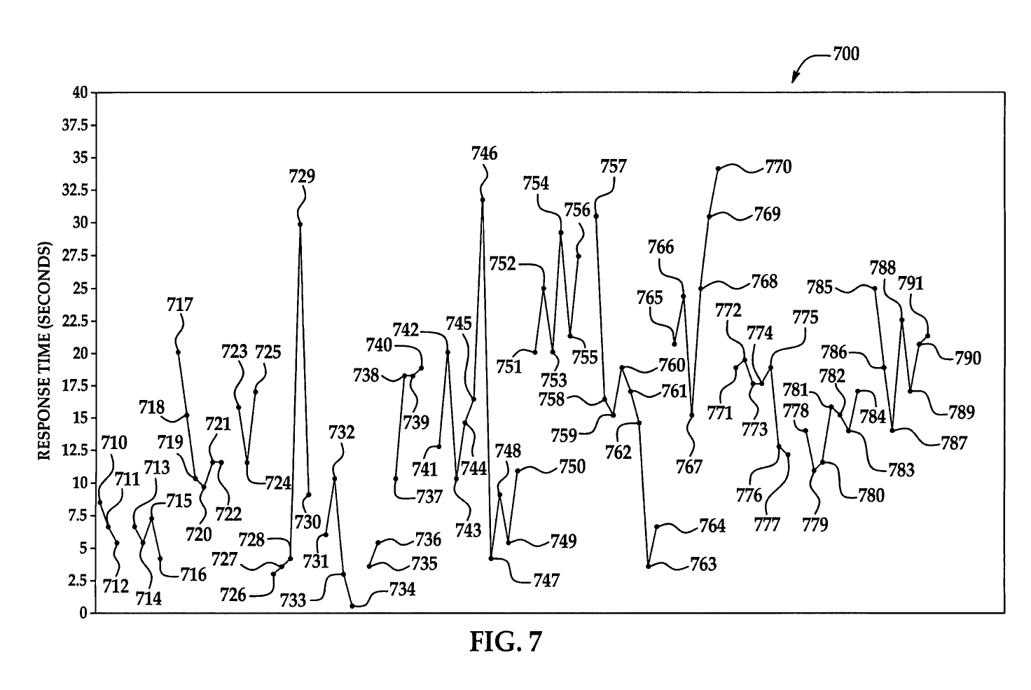

Referring now to FIG. 7, a graphical representation 700 of the response time in seconds is shown for fifteen NOx sensor cells. The NOx sensor electrodes were prepared by using TbCr_{0.8}Mg_{0.20}O₃, which has been calcined at 1000° C. for 19 hours, and then at 1100° C. for 43 hours, and disposed using an ink formulation comprising 99 wt % TbCr_{0.8}Mg_{0.20}O₃, 1 wt % glass, and a low ash solvent at a concentration which allows printing onto electrolyte. This was heated at 8° C./min to a firing temperature of 1400° C., where it was kept for 1 hr, and followed by 8° C./min cooling to room temperature.

The response time for each NOx sensor cell was measured. The response time represents the time to obtain a final reading after increasing the amount of NO₂ from 20 ppm to 200 ppm in a mixture of gases comprising the NO₂ and 10 ppm NH₃, with the background gas being N₂. Several response time measurements were performed on every one of the fifteen sensor cells. Every point 710-791 in FIG. 7 represents a response time measurement, and the plurality of points joined by straight lines represent response time measurements on the same sensor cell. For example, three response time measurements 710-712 were performed on one sensor cell, while five response time measurements 726-730 were performed on another sensor cell.

It can be seen that the response time was inconsistent, slow, and varied between about 1 second to about 34 seconds. The response time from the same sensor cell was also inconsistent. For example, response time measurements 757 and 763 are for the same sensor cell, but they vary from about 4 seconds for measurement 763, to about 30 seconds for measurement 757.

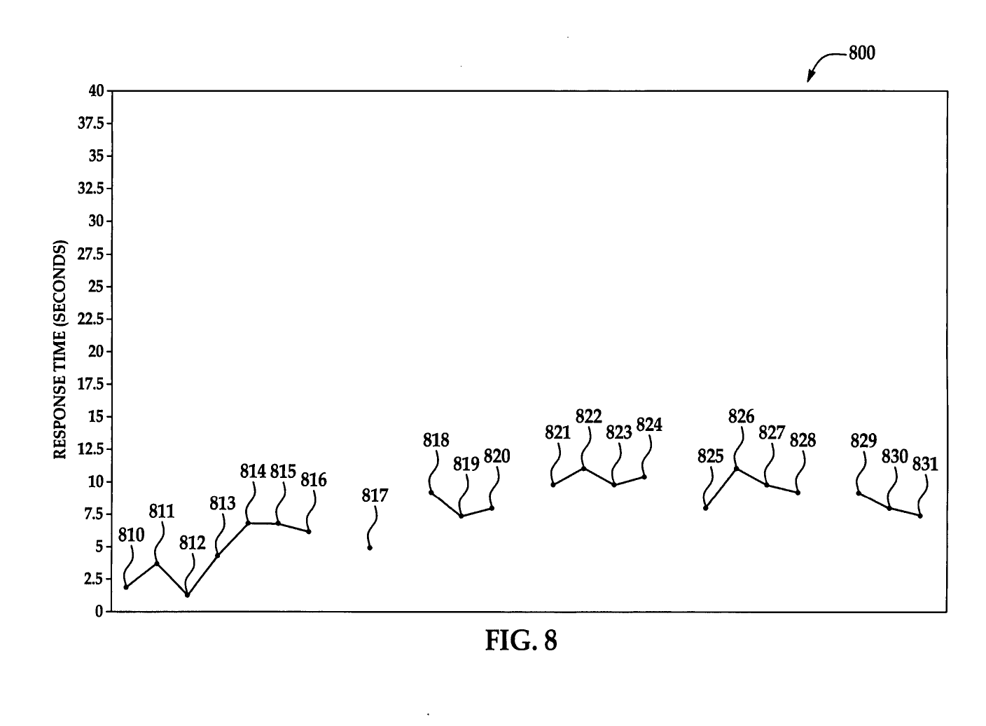

FIG. 8, on the other hand, is a graphical representation 800 of the response time in seconds for six NOx sensor cells, wherein the NOx sensor electrodes were prepared by using TbCr_{0.8}Mg_{0.20}O₃, which has been calcined at 1000° C. for 19 hours, then at 1100° C. for 43 hours, and then at 1400° C. for 10 hours, and disposed using an ink formulation comprising 99 wt % TbCr_{0.8}Mg_{0.20}O₃, 1 wt % glass, and a low ash solvent at a concentration which allows printing onto electrolyte. This was heated at 8° C./min to a firing temperature of 1400° C., where it was kept for 1 hr, and followed by 8° C./min cooling to room temperature.

Similar to above, the response time for each NOx sensor cell was measured after increasing the amount of NO₂ from 20 ppm to 200 ppm in a mixture of gases comprising the NO₂ and 10 ppm NH₃, with the background gas being N₂. One or several response time measurements were performed on every one of the six sensor cells. Every point 810-831 in FIG. 8 represents a response time measurement, and the plurality of points joined by straight lines represent response time measurements on the same sensor cell. For example, seven response time measurements 810-816 were performed on one sensor cell, while one response time measurement 817 was performed on another sensor cell.

It can be seen that the resulting response times were much more consistent when compared to those of FIG. 7, with very little variation, the highest variation being between about 1 to about 11 seconds.

The method of making the gas sensor element, the NOx sensor electrodes, NOx sensor cells, gas sensor elements and gas sensors disclosed herein results in a more accurate, more consistent, and more rapid NOx determination than was possible without calcining the NOx sensor electrode material at a NOx sensor electrode material calcination temperature of about 1200 to about 1600° C. The response time and the consistency of the measurements are improved. The devices have wide temperature ranges of operation and are independent of the flow rate of the exhaust.

This written description uses figures in reference to exemplary embodiments to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

All cited patents, patent applications, and other references are incorporated herein by reference in their entirety unless otherwise indicated. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other. Further, it is understood that disclosing a range is specifically disclosing all ranges formed from any pair of any upper range limit and any lower range limit within this range, regardless of whether ranges are separately disclosed. It is not intended that the scope of the invention be limited to the specific values recited when defining a range.

The use of the terms “a”, “an”, “the”, and similar referents in the context of describing the invention (especially in the context of the following claims) are to be construed to cover both the singular and the plural, unless otherwise indicated herein or clearly contradicted by context. Further, it should be noted that the terms “first”, “second”, and the like herein do not denote any order, quantity, or importance, but rather are used to distinguish one element from another.

The modifier “about” used in connection with a quantity is inclusive of the stated value and has the meaning dictated by the context (e.g., it includes the degree of error associated with measurement of the particular quantity).

What is claimed is:

1. A method of making a gas sensor element, comprising:
calcining a NOx sensor electrode material at a NOx sensor electrode material calcination temperature of about 1200 to about 1600° C. to form a calcined NOx sensor electrode material;
disposing the calcined NOx sensor electrode material on a substrate to form a substrate comprising a NOx sensor electrode; and
firing the substrate comprising the NOx sensor electrode at a gas sensor element firing temperature to form a gas sensor element comprising a NOx sensor electrode.

2. The method of making the gas sensor element of claim 1, wherein the gas sensor element is a NOx sensor element, an oxygen sensor element, a hydrogen sensor element, a carbon monoxide sensor element, an unburned hydrocarbon gases sensor element, an ammonia sensor element, or a combination thereof.

3. The method of making the gas sensor element of claim 1, wherein the substrate comprises a solid electrolyte and a reference electrode.

4. The method of making the gas sensor element of claim 3, wherein the solid electrolyte comprises zirconia.

5. The method of making the gas sensor element of claim 3, wherein the reference electrode is in intimate contact and ionic communication with the solid electrolyte.

6. The method of making the gas sensor element of claim 5, wherein the reference electrode comprises platinum, palladium, gold, osmium, rhodium, iridium, ruthenium, an alloy thereof, an oxide thereof, or a combination thereof.

7. The method of making the gas sensor element of claim 5, wherein the NOx sensor electrode is in intimate contact and ionic communication with the solid electrolyte.

8. The method of making the gas sensor element of claim 7, wherein the NOx sensor electrode is disposed on the gas sensor such that it is operative for fluid communication with a sample gas.

9. The method of making the gas sensor element of claim 1, wherein the NOx sensor electrode material comprises YbCrO₃, LaCrO₃, ErCrO₃, EuCrO₃, SmCrO₃, HoCrO₃, GdCrO₃, NdCrO₃, TbCrO₃, ZnFe₂O₄, MgFe₂O₄, ZnCr₂O₄, or a combination thereof.

10. The method of making the gas sensor element of claim 9, wherein the NOx sensor electrode material is doped with barium, titanium, tantalum, potassium, calcium, strontium, vanadium, silver, cadmium, lead, tungsten, tin, manganese, nickel, zinc, sodium, zirconium, niobium, cobalt, magnesium, rhodium, boron, phosphorus, germanium, aluminum, silicon, a lanthanoid element, or a combination thereof.

11. The method of making the gas sensor element of claim 10, wherein the NOx sensor electrode material is TbCr_{0.8}Mg_{0.2}O₃.

12. The method of making the gas sensor element of claim 11, wherein the NOx sensor electrode material is further doped with calcium, strontium, boron, lead, phosphorus, germanium, barium, silicon, aluminum, a lanthanoid element other than Tb, or a combination thereof.

13. The method of making the gas sensor element of claim 10, wherein the NOx sensor electrode material is selected from the group consisting of TbCr_{0.8}Mg_{0.20}O₃, TbCr_{0.8}Mg_{0.15}B_{0.05}O₃, TbCr_{0.8}Mg_{0.1}B_{0.10}O₃, TbCr_{0.7}Mg_{0.1}B_{0.2}O₃, TbCr_{0.5}Mg_{0.1}B_{0.4}O₃, TbCr_{0.99}Mg_{0.01}Pb_{0.01}O₃, TbCr_{0.8}Mg_{0.15}Pb_{0.05}O₃, TbCr_{0.8}Mg_{0.15}P_{0.05}O₃, Tb_{0.99}La_{0.01}Cr_{0.8}Mg_{0.175}B_{0.025}O₃, TbCr_{0.8}Ba_{0.20}O₃, and TbCr_{0.8}Si_{0.20}O₃.

14. The method of making the gas sensor element of claim 1, wherein the NOx sensor electrode material calcination temperature is about 1350 to about 1450° C.

15. The method of making the gas sensor element of claim 1, wherein calcining the NOx sensor electrode material is for about 1 to about 20 hours.

16. The method of making the gas sensor element of claim 1, further comprising, prior to calcining the NOx sensor electrode material at the NOx sensor electrode material calcination temperature, calcining a mixture of metal oxide precursors at a first NOx sensor electrode material precursor calcination temperature of about 100 to about 1140° C. to form the NOx sensor electrode material.

17. The method of making the gas sensor element of claim 1, further comprising, prior to calcining the NOx sensor electrode material at the NOx sensor electrode material calcination temperature, calcining a mixture of metal oxide precursors at a first NOx sensor electrode material precursor calcination temperature of about 100 to about 1140° C. to form a first NOx sensor electrode material precursor, and calcining the first NOx sensor electrode material precursor at a second NOx sensor electrode material precursor calcination temperature of about 200 to about 1140° C. to form the NOx sensor electrode material.

18. The method of making the gas sensor element of claim 1, wherein the gas sensor element firing temperature is no more than about 50° C. higher than the NOx sensor electrode material calcination temperature.

19. The method of making the gas sensor element of claim 18, wherein the gas sensor element firing temperature is about 1000 to about 1500° C.

20. A gas sensor, comprising a gas sensor element prepared by:
calcining a NOx sensor electrode material at a NOx sensor electrode material calcination temperature of about 1200 to about 1600° C. to form a calcined NOx sensor electrode material;
disposing the calcined NOx sensor electrode material on a substrate to form a substrate comprising a NOx sensor electrode; and
firing the substrate comprising the NOx sensor electrode at a gas sensor element firing temperature to form a gas sensor element comprising a NOx sensor electrode.
